(19) United States
(12) Patent Application Publication
(10) Pub. No.: US 2008/0168689 A1
(43) Pub. Date: Jul. 17, 2008

(54) Information card and holder for refrigerator

(75) Inventors: Chad A. Wohlrab, Madison, WI (US); Curtis L. Cruver, Elmhurst, IL (US)

Correspondence Address: FOLEY & LARDNER LLP, 777 EAST WISCONSIN AVENUE, MILWAUKEE, WI, 53202-5306, US

(73) Assignee: Sub-Zero Freezer Company, Inc.

(21) Appl. No.: 11/654,342

(22) Filed: Jan. 17, 2007

(51) Int. Cl. G09F 1/12

(52) U.S. Cl. 40/124.06

(57) ABSTRACT

A refrigerator includes a refrigerator body, an information card, and at least one door pivotally coupled to the refrigerator body. The refrigerator body includes a recess configured to receive the information card, the recess having an interior portion that substantially conforms to the exterior of the information card.

### BACKGROUND

The present invention relates generally to the field of refrigerators, and more specifically, to a refrigerator having an information card and a holder for the information card.

Typically, a refrigerator purchased by a consumer will be provided with a user's manual, reference guide, or other manual, etc. that may include information and/or instructions related to maintenance of and care for the refrigerator, proper use of the refrigerator, and/or suggestions or tips on, for example, how or where to store various types of food products (food, beverages, etc.).

One problem associated with many refrigerators is that there is often no convenient, secure, and readily accessible place to store the reference manual, and such documents tend to become lost or misplaced during the long years of service typically provided by an appliance such as a refrigerator.

Accordingly, it would be advantageous to provide a refrigerator having an information card or other source of information that may be stored in a portion of the refrigerator such that it is easily accessible when needed.

Another problem associated with refrigerators is that there may be wasted or unused space within the refrigerated compartment. For example, fixtures, spacers, or other devices may be required to permit proper functioning of various components (e.g., adjustable shelves, drawers, etc.) of the refrigerator, and the space occupied by these fixtures, spacers, and other devices is often not available for storage of food products and may be otherwise unused space. For example, a spacer may be required to offset a refrigerator drawer from a sidewall such that the drawer may be properly and fully opened when the door is open to approximately 90 degrees.

Accordingly, it would further be advantageous to provide a refrigerator that uses existing fixtures and/or spacers containing otherwise unused areas of space to permit a user to store an information card or other manual, guide, etc. in an easily accessible and secure location.

Accordingly, it would be desirable to provide a refrigerator, having an information card and a holder for the information card, that provides one or more of these or other advantageous features or addresses one or more of the above-identified needs. Other features and advantages will be made apparent from the present specification. The teachings disclosed herein extend to those embodiments that fall within the scope of the appended claims, regardless of whether they accomplish one or more of the above-identified needs.

### SUMMARY

One embodiment of the invention relates to a refrigerator comprising a refrigerator body, an information card, and at least one door pivotally coupled to the refrigerator body. The refrigerator body includes a recess configured to receive the information card, the recess having an interior portion that substantially conforms to the exterior of the information card.

Another embodiment of the invention relates to an appliance comprising an interior surface having at least one sidewall, and a card holder attached to the at least one sidewall. The card holder has a cavity and an information card is removably inserted into the cavity.

Yet another embodiment of the invention relates to an information card and holder for an appliance comprising a spacer and an information card. The spacer includes a cavity configured to receive the information card, and the spacer comprises a panel and an insert that define the cavity.

The invention is capable of other embodiments and of being practiced and carried out in various ways. Alternative exemplary embodiments relate to other features and combinations of features as may be generally recited in the claims.

### BRIEF DESCRIPTION

The invention will become more fully understood from the following detailed description, taken in conjunction with the accompanying drawings, wherein like reference numerals refer to like elements, in which:

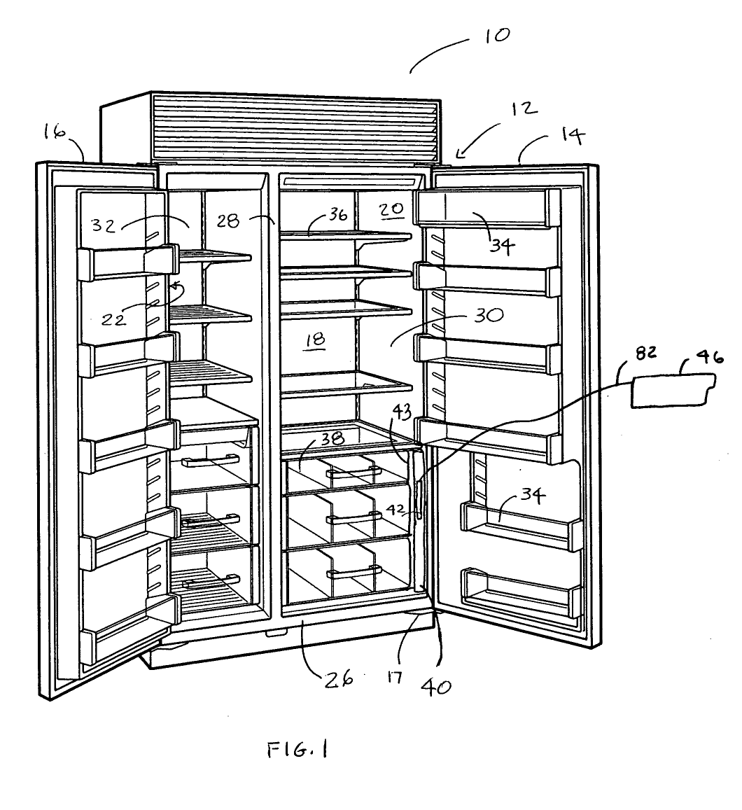

FIG. 1 is a front view of a refrigerator according to an exemplary embodiment;

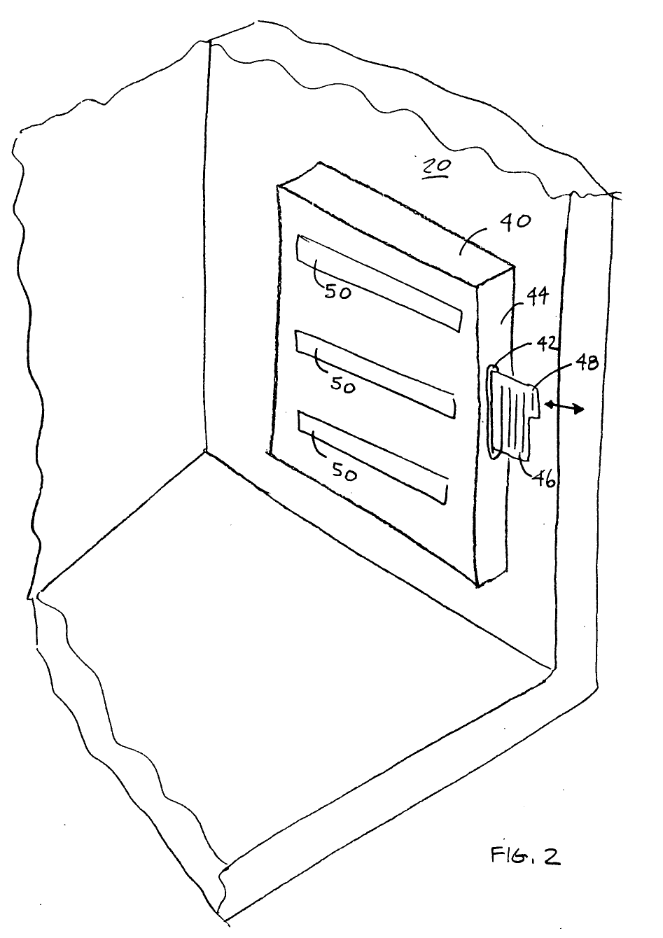

FIG. 2 is a partial perspective view of the interior portion of the refrigerator of FIG. 1 according to an exemplary embodiment;

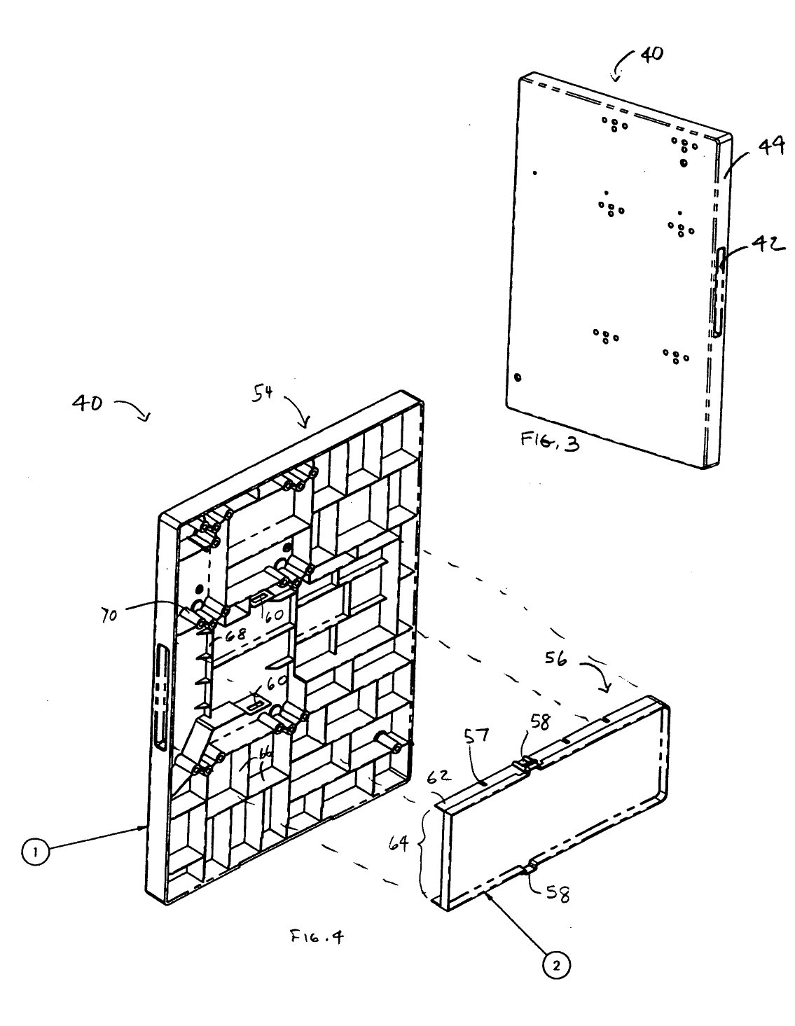

FIG. 3 is a perspective view of a spacer assembly of the refrigerator of FIG. 1 according to an exemplary embodiment;

FIG. 4 is an exploded view of the spacer assembly of FIG. 3 according to an exemplary embodiment; and

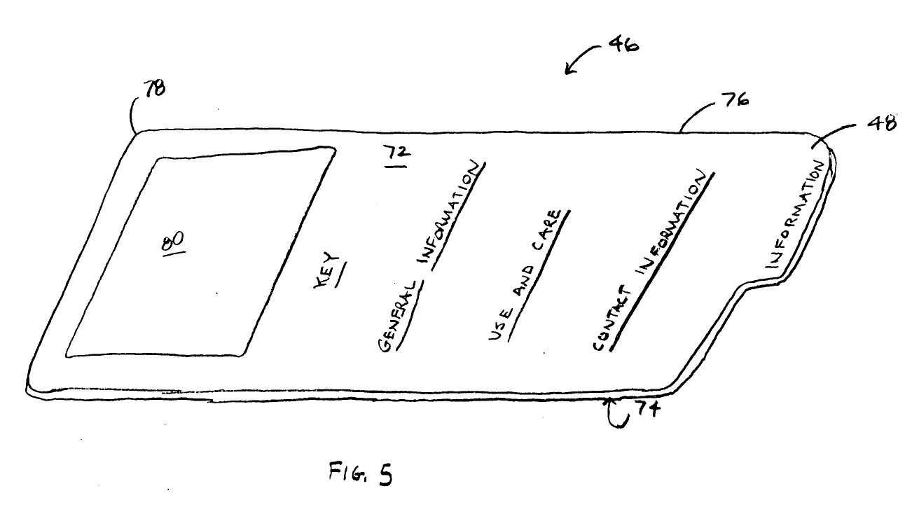

FIG. 5 is a perspective view of an information card according to an exemplary embodiment.

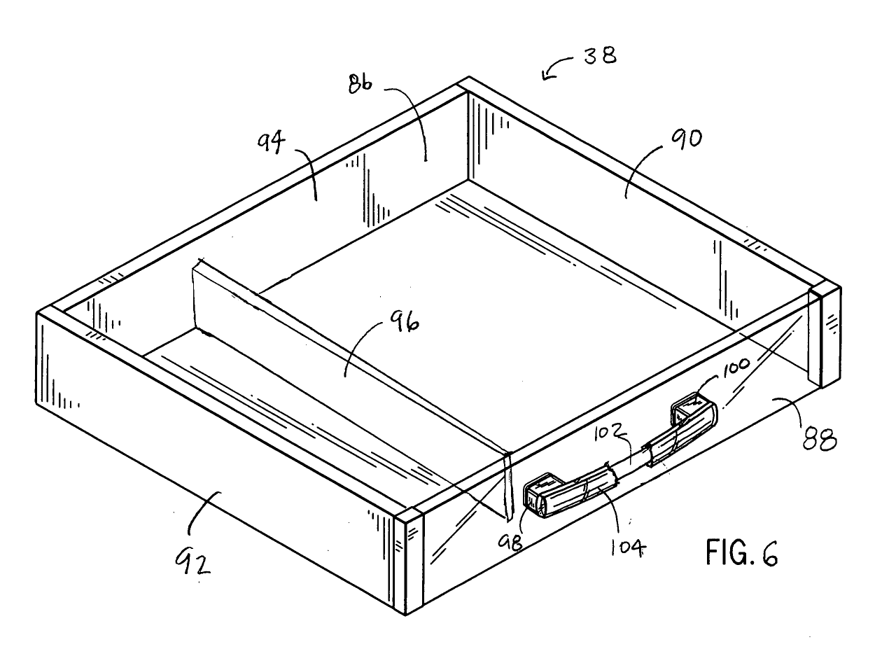

FIG. 6 is a perspective view of a storage compartment according to an exemplary embodiment.

### DETAILED DESCRIPTION

Referring to FIG. 1, a refrigerator 10 is shown. Refrigerator 10 includes a body portion 12, and doors 14, 16. Doors 14, 16 are pivotally attached to body portion 12 such that doors 14, 16 may be moved between a closed position and an open position for access to food products stored within refrigerator 10. Doors 14, 16 may be pivotally attached to body portion 12 using a hinge such as hinge 17 or any other suitable method. Refrigerator 10 is a “side-by-side” style refrigerator. It should be understood that the teachings herein extend to other types and configurations of refrigerators, including “top-bottom” style units, “chest” type units, and so on.

Further referring to FIG. 1, body portion 12 may include various wall portions, including a back wall 18, opposing side walls 20, 22, and top and bottom walls 24, 26. Body portion 12 may further include one or more intermediate walls, such as divider wall 28. As shown in FIG. 1, the wall portions define interior cavities or compartments 30, 32. According to one embodiment, both cavities 30 and 32 are used for refrigeration purposes. According to another embodiment, one or both of cavities 30, 32 may be used as a freezer compartment. As shown in FIG. 1, when doors 14, 16 are in the open position, cavities 30, 32 are accessible from the exterior of the refrigerator. It should be understood that the embodiments and teachings disclosed herein with respect to only one of cavities 30, 32 extend to both of cavities 30, 32 according to various alternative embodiments. It should be further understood that refrigerator 10 may be used having only one of cavities 30 and 32.

Referring further to FIG. 1, door 14 may include one or more storage shelves 34 having varying heights and widths and being adjustable along the height of door 14. Similarly, refrigerator body 12 may include one or more storage shelves 36 and one or more storage compartments 38 located within cavity 30 and positioned between divider wall 28 and sidewall 20. According to one embodiment, storage compartment 38 is a drawer that is slidably adjustable, and a spacer 40 (e.g., a support member, an information card holder, etc.) is positioned between storage compartment 38 and sidewall 20. Spacer 40 maintains the proper spacing between a side 43 of storage compartment 38 and sidewall 20 such that storage compartment 38 may be pulled fully open when door 14 is open to 90 degrees with respect to the closed position. In certain instances, without a component such as spacer 40, the thickness of door 14 may prevent storage compartment 38 from being properly opened except when door 14 is pivoted substantially beyond the 90 degree position (with respect to the closed position).

As shown in FIG. 1, storage compartment 38 may be a drawer that holds various food products and is slidably adjustable such that the contents of the drawer may be accessed when the drawer is slid outward from refrigerator body 12. According to an alternative embodiment, storage compartment 38 may comprise a storage shelf rather than a drawer, and the storage shelf may likewise be slidably adjustable. According to yet another embodiment, storage compartment 38 may be further adjustable in a vertical direction, or may include pivoting members, etc. to enhance the adjustability of storage compartment 38.

Referring now to FIGS. 1-3, according to one embodiment of the invention, spacer 40 includes a slot 42 (e.g., a hole, opening, aperture, etc.) that opens to a front surface 44 of spacer 40 to provide access to a recess (e.g., a cavity, receptacle, etc.) defined by a first member, shown as panel 54, and a second member, shown as insert 56 (see FIG. 4). Slot 42 is configured to receive an information card 46 (e.g., a reference manual, a user guide, etc.). When card 46 is slid fully into slot 42, a graspable portion 48 of card 46 may remain to the exterior of slot 42, thereby providing a portion that users may use to pull card 46 from slot 42. According to an alternative embodiment, the full length of card 46 may fit within slot 42, and access to card 46 may be provided by one or more finger recesses, etc. provided adjacent slot 42, thereby permitting a user to remove card 46 from slot 42. According to another alternative embodiment, card 46 may be attached to spacer 40 via a retainer 82 (e.g., a tether, strap, etc.) such that card 46 remains coupled to spacer 40 even when card 46 is removed. According to various other embodiments, other means of retaining card 46 may be used, and retainer 82 may be attached to other portions of refrigerator 10.

Referring further to FIG. 2, one or more attachment members 50 (e.g., slide mechanisms, slide surfaces, etc.) may be provided on a side surface 52 of spacer 40. For example, attachment members 50 may comprise sliding mechanisms that attach to storage compartment 38 and permit a user to pull storage compartment 38 in an outward direction with respect to cavity 30, thereby providing access to the contents of storage compartment 38. As shown in FIG. 2, three attachment members 50 are secured to spacer 40. According to various other embodiments, more or fewer attachment members may be utilized having various configurations and orientations.

Referring now to FIG. 4, spacer 40 is shown in greater detail. As shown in FIG. 4, spacer 40 may include panel 54 and insert 56. Insert 56 is secured to panel 54 to form slot 42. As shown in FIG. 4, insert 56 has two fasteners 58 (e.g., clips, tabs, projections, etc.) that engage corresponding fasteners 60 on panel 54 to secure insert 56 to panel 54. According to one embodiment, fasteners 58, 60 and panel 54 and insert 56 are fastened in a “snap fit” fashion. Other types of fasteners (e.g., screws, bolts, etc.) may alternatively be used. One or more slots 57 in insert 56 may engage one or more recessed cross members 68 to provide additional stability and rigidity and further fasten insert 56 to panel 54. Insert 56 also has a perimeter edge portion 62 that extends along three edges of insert 56 and conforms substantially to the perimeter dimensions of card 46. A portion 64 is provided without edge portion 62 such that card 46 may be inserted into and removed from slot 42.

Referring further to FIG. 4, panel 54 has a number of cross-members 66 that provide structural rigidity to spacer 40. In the portion of panel 54 that forms slot 42, recessed cross-members 68 are provided that have a lower profile than cross-members 66 and allow card 46 to move within slot 42. Recessed cross-members 68, in addition to providing additional structural support for and rigidity to panel 54, may also provide a low-friction surface on which card 46 may be slid into and out of slot 42. According to one embodiment, cross members 66 and recessed cross-members 68 are formed as an integral part of panel 54. According to an alternative embodiment, cross members 66 and recessed cross members 68 are formed as separate pieces apart from panel 54 and are attached during a secondary operation.

As shown in FIG. 4, cross members 66 and recessed cross members 68 are positioned in a generally perpendicular fashion on panel 54. According to various alternative embodiments, cross members 66 and/or recessed cross members 68 may be curved or angled members that define angled or other types of intersections at the crossing points of the various members.

Panel 54 also includes a number of post portions or posts 70. Posts 70 may be used to receive fasteners (e.g., screws, bolts, etc.) that may fasten attachment member 50 to spacer 40 and/or sidewall 20, or spacer 40 to sidewall 20. According to one embodiment, the posts may have a height generally the same as cross members 66. Posts 70 may further be used to fasten insert 56 to panel 54. For example, posts 70 may have through-holes designed to allow a threaded fastener to pass though post 70 and secure, for example, attachment member 50 to sidewall 20. Alternatively, posts 70 may include internal threads for fastening components directly to spacer 40. Other fastening devices and methods may alternatively be used.

Referring now to FIG. 5, card 46 according to one embodiment is shown in greater detail. Card 46 includes front and back surfaces 72, 74, respectively, and a perimeter edge 76. Card 46 also includes graspable portion or tab 48 on one end (or both ends, if intended to be inserted in both directions, or “reversible”). According to one embodiment, when card 46 is fully slid into or seated within slot 42, tab 48 remains exposed such that a user may grasp tab 48 and remove card 46 from slot 42 (and subsequently return card 46 to slot 42). Card 46 may have one or more rounded corners 78 that facilitate the insertion and removal of card 46 into and out of slot 42. According to an exemplary embodiment, card 46 has an exterior that substantially conforms to the interior contour of slot 42. For example, card 46 may have a thickness that is slightly less than the width of slot 42 such that card 46 may be slid into slot 42 with a snug fit, and held in place once fully seated within the slot.

While card 46 is shown as a generally rectangular item, other shapes may additionally be used. According to one embodiment, card 46 is a generally rigid member and is made from a plastic-coated (e.g., laminated) material such as cardboard or other material that is suitable for extended periods of storage within a refrigerated environment such as cavity 30. Further, card 46 may comprise multiple cards or sheets that may be bound together and may be opened in a book-like fashion. Further yet, card 46 may be a foldable card that may be folded to a size corresponding to slot 42, and then unfolded to a larger size, thereby increasing the amount of information that may be contained on front and/or back surfaces 72, 74. According to one embodiment, information card 46 may further comprise audio and/or visual electronic media materials (e.g., a compact disc, a DVD, etc.) storing additional information for users.

Card 46 may contain various types of information and may further include graphics, etc. on one or more of surfaces 72, 74. One advantage of providing refrigerator 10 with card 46 is that card 46 provides point of use information for consumers. For example, card 46 may contain information such as a color-coded illustration 80 of a corresponding refrigerator assembly (e.g., refrigerator 10), use and care information, maintenance instructions, and so on. A user wishing to find out certain information regarding refrigerator 10 may simply open door 14 to expose card 46 seated in slot 42, remove card 46 to obtain the necessary information, and return card 46 to slot 42 for later use. According to an alternative embodiment, card 46 may further include contact information, for example, for the manufacturer of the refrigerator, a service entity, etc., to permit a user to obtain information in addition to that provided on card 46. Other information may additionally be provided on card 46 in a variety of formats and configurations.

Referring to FIGS. 1 and 6, (food) storage compartment or drawer 38 is shown in more detail. Storage compartment 38 may be used as an upper drawer, a middle drawer, and/or a lower drawer (see FIG. 1). Drawers 38 (e.g., bin, basket, container, holder, etc.) are sometimes referred to as “crispers” and are slidably coupled to sidewalls by attachment members or rails 50 (e.g., tracks, slides, glides, etc.). According to a preferred embodiment, drawers 38 each includes a handle 84 and a plurality of walls or panels that form a cavity 86 with an open top to provide access to cavity 86 when slid out from refrigerator compartment 30. One or more of the panels (e.g., the front panel 88) is preferably transparent to allow visual access to the contents of cavity 86. The panels include front panel 88, side panels 90, 92, a rear panel 94, and one or more dividers 96. Handle 84 is attached to front panel 88 by fasteners engaging a pair of spaced apart stand-offs 98, 100. Preferably, handle 84 is positioned approximately midway between the top of front panel 88 and the bottom of front panel 88 (i.e., generally centered on front panel 88). According to an exemplary embodiment, handle 84 includes an opaque portion (e.g., a white member) extending across substantially the width of handle). According to a preferred embodiment, handle 84 includes an opaque base portion 102 and a transparent outer portion 104. According to a particularly preferred embodiment, opaque base portion 102 and a transparent outer portion 104 are coupled together by an insert molding operation that molds the transparent portion at least partially around opaque portion. The transparent front panel (and other panels of the drawer(s)) and the opaque handle (or opaque with transparent outer layer) is intended to provide a desired contrast and appearance. According to yet another embodiment, divider 96 is coupled to front panel 88 using a tab or other fastening device at a location such that stand-off 98 obscures the coupling of divider 96 to front panel 88.

As shown in the FIGURES, slot 42 is provided as a part of spacer 40, and when door 14 is in the closed position, slot 42 and card 46 are not viewable by a user of refrigerator 10. According to another embodiment, door 14 comprises a transparent material and slot 42 and card 46 may be viewable when door 14 is in the closed position. According to various alternative embodiments, slot 42 and/or spacer 40 may be provided in a variety of alternative locations. For example, spacer 40 may be attached to a sidewall or wall portion other than sidewall 20 (depending on the configuration of the refrigerator, etc.). Further, spacer 40 may be oriented in a horizontal or other position, rather than vertical position. Further yet, spacer 40 may be an integral part of one or more of the sidewalls or other portions of refrigerator 10. Similarly, slot 42 may be located on other components of refrigerator 10, including, among other places, one of the sidewalls, a top or bottom wall, the door, and so on. For example, slot 42 may be provided in a portion (e.g., an edge portion) of door 14. Further, slot 42 may be oriented vertically or horizontally or at an intermediate angle. Further yet, slot 42 may be provided with a lower surface that declines toward the rear of the slot, therefore providing an inclined support surface and additional support and security for retaining the card within the slot.

It is important to note that the construction and arrangement of the refrigerator and information card and holder as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements (e.g., panel 54 and/or insert 56 may comprise multiple sub-components), the position of elements may be reversed or otherwise varied (e.g., the spacer may be located on various wall portions of the refrigerator), and the nature or number of discrete elements or positions may be altered or varied. Also, while this disclosure is generally directed to refrigerators, the teachings contained herein may extend to various other types of devices and appliances, such as freezers, ovens, stove units, microwave units, dishwasher units, or the like. Accordingly, all such modifications are intended to be included within the scope of the present invention as defined in the appended claims.

The order or sequence of any process or method steps may be varied or resequenced according to alternative embodiments. In the claims, any means-plus-function clause is intended to cover the structures described herein as performing the recited function and not only structural equivalents but also equivalent structures. Other substitutions, modifications, changes, and omissions maybe made in the design, operating conditions, and arrangement of the exemplary embodiments without departing from the scope of the present inventions as expressed in the appended claims.

What is claimed is:

1. A refrigerator, comprising:
a refrigerator body;
an information card; and
at least one door pivotally coupled to the refrigerator body;
wherein the refrigerator body includes a recess configured to receive the information card, the recess having an interior portion that substantially conforms to the exterior of the information card.

2. The refrigerator of claim 1, wherein the refrigerator body further comprises a spacer, the spacer including a panel and an insert that are secured together in a snap fit fashion and define the recess.

3. The refrigerator of claim 2, further comprising at least one storage compartment coupled to the spacer.

4. The refrigerator of claim 3, further comprising:
a hinge assembly that pivotally couples the door to the body;
wherein the refrigerator body includes opposing wall portions, and the spacer is located on the same wall portion as the hinge assembly.

5. The refrigerator of claim 4, wherein the panel and the insert are made of a thermoplastic material.

6. The refrigerator of claim 1, wherein the recess is not viewable from the exterior of the refrigerator when the door is in a closed position.

7. The refrigerator of claim 1, wherein the recess has a first length and at least a portion of the information card has a second length, the second length being greater than the first length such that the at least a portion of the information card extends beyond the recess when the information card is held in the recess.

8. The refrigerator of claim 1, wherein the information card comprises at least one rounded corner configured to facilitate inserting the information card into the recess.

9. The refrigerator of claim 8, wherein the information card provides at least one of a graphical illustration of the refrigerator, operating instructions for the refrigerator, maintenance instructions for the refrigerator, contact information for a service provider, or a combination thereof.

10. The refrigerator of claim 9, wherein the information card is foldable to a folded position, and the interior portion of the recess substantially conforms to the information card in the folded position.

11. An appliance, comprising:
an interior surface having at least one sidewall;
a card holder attached to the at least one sidewall, the card holder having a cavity; and
an information card removably inserted into the cavity.

12. The appliance of claim 11, wherein the card holder comprises a panel and an insert that define the cavity, the panel and the insert being coupled in a snap fit fashion.

13. The appliance of claim 11, wherein the at least one sidewall defines an interior, the interior opening to a front surface of the appliance, wherein the cavity opens toward the front surface.

14. The appliance of claim 11, further comprising:
a hinge;
wherein the at least one sidewall comprises first and second opposing sidewalls, the spacer and the hinge being attached to the first sidewall.

15. The appliance of claim 11, wherein the appliance is a refrigerator.

16. An information card and holder for an appliance, comprising:
a spacer; and
an information card;
wherein the spacer includes a cavity configured to receive the information card; and
wherein the spacer comprises a panel and an insert that define the cavity.

17. The information card and holder of claim 16, wherein the panel comprises a plurality of cross members, wherein at least a portion of the cross members are recessed cross members that define at least a portion of the cavity.

18. The information card and holder of claim 17, wherein the recessed cross members comprise a low-friction surface configured to slidably engage the information card.

19. The information card and holder of claim 16, wherein the appliance is one of a refrigerator and a freezer.

20. The information card and holder of claim 16, further comprising:
a retainer coupled to the information card and the spacer.
